(19) United States
(12) Patent Application Publication
(10) Pub. No.: US 2011/0254321 A1
(43) Pub. Date: Oct. 20, 2011

(54) ARRANGEMENT FOR REMOVING WATER FROM THE ROOF OF AN AUTOMOBILE

(75) Inventors: Angel Moral, Valladolid (ES); Pascal Santandreu, Emance (FR); Olivier Bisror, Le Plessis Robinson (FR)

(73) Assignee: RENAULT s.a.s., Boulogne-Billancourt (FR)

(21) Appl. No.: 13/062,142

(22) PCT Filed: Aug. 4, 2009
(86) PCT No.: PCT/FR2009/051550

§ 371 Date: Jun. 22, 2011

(30) Foreign Application Priority Data
Sep. 8, 2008 (FR) 0804926

(51) Int. Cl. B60R 13/07; B29C 45/00

(52) U.S. Cl. 296/213; 264/328.1

(57) ABSTRACT

A device for a water-removing arrangement for an automobile, wherein the device is provided as an angled plastic part including a first end, connectable to a mechanism for inserting a metal sheet of an automobile, and a second end, connectable to a water removal pipe.

The invention relates to a device for removing water for a roof of a motor vehicle and to an arrangement comprising this device for removing the water from a roof of a motor vehicle. It also relates to a method of manufacturing such a device and finally covers a motor vehicle as such fitted with such a device.

Conventionally, water is removed from a roof of a motor vehicle by a pipe attached under a plate welded to a structural element of the roof of a motor vehicle. This plate has an opening corresponding to the pipe and water is removed from the top surface of the roof of the vehicle through this opening and is then guided in a downward direction by the pipe. In the case of roofs that are laser-welded to the lateral bodywork elements, for example in the case of large sunroofs, where there is no roof gutter via which the water can be removed in the conventional way, the traditional solution is a reinforcing plate mounted on the lateral part of the roof. This solution for removing water generates spaces in which water can accumulate.

There is therefore a need for an alternative solution for removing water from a roof of a motor vehicle.

One objective of the present invention is therefore to provide a device for removing water for a motor vehicle, suited to a great many motor vehicles including those that have a laser-welded roof structure.

To this end, the invention relies upon a device of an arrangement for removing water for a motor vehicle, characterized in that it takes the form of a bent plastic component comprising a first end designed for connection with a means of engagement for a sheet metalwork panel of a motor vehicle, and a second end designed for connection to a water discharge pipe.

The first end designed for connection to a means of engagement may comprise a means designed to be clipped into the counterbore of the means of engagement. It may comprise a tapped thread. Finally, it may comprise at least one polarizing lug to ensure the correct orientation of the device.

The plastic component may have a housing designed to accept a seal.

The invention also relates to a method of manufacturing a device of an arrangement for removing water for a motor vehicle, characterized in that it comprises a step of injecting a plastics material into a mold to form a bent plastic component comprising a first end designed for connection with a means of engagement for a sheet metalwork panel of a motor vehicle, and a second end designed for connection to a water discharge pipe.

The invention also relates to an arrangement for removing water from the roof of a motor vehicle, comprising a means of engagement intended to be fitted into an opening in the roof of the motor vehicle, characterized in that it comprises a bent plastic component comprising a first end designed for connection with the means of engagement, and a second end designed for connection to a water discharge pipe.

The means of engagement may form a sunken nut allowing it to be fitted blind into the opening in the roof of the motor vehicle, and intended to be crimped to the sheet metalwork panel by pulling.

The invention also relates to a motor vehicle comprising an arrangement for removing water from its roof as described hereinabove.

These objects, features and advantages of the present invention will be explained in detail in the following description of one particular embodiment given nonlimitingly with reference to the attached figures among which:

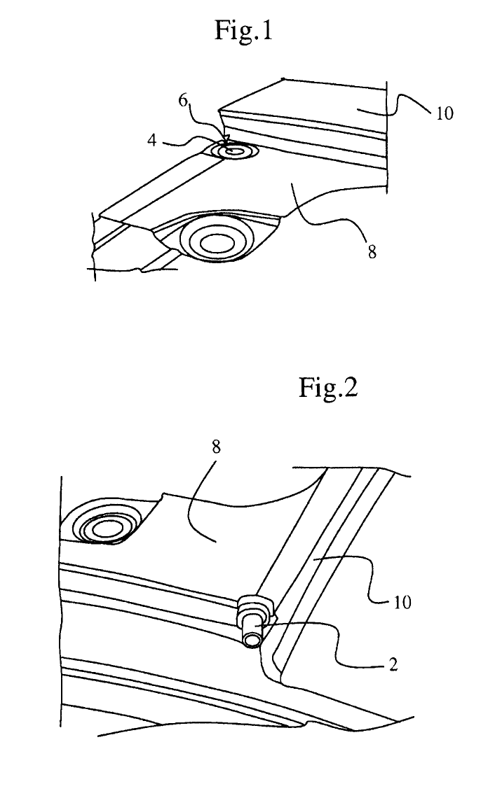

FIG. 1 is a schematic depiction of an arrangement for removing water according to one embodiment of the invention;

FIG. 2 is a view from beneath of the arrangement depicted in the above figure;

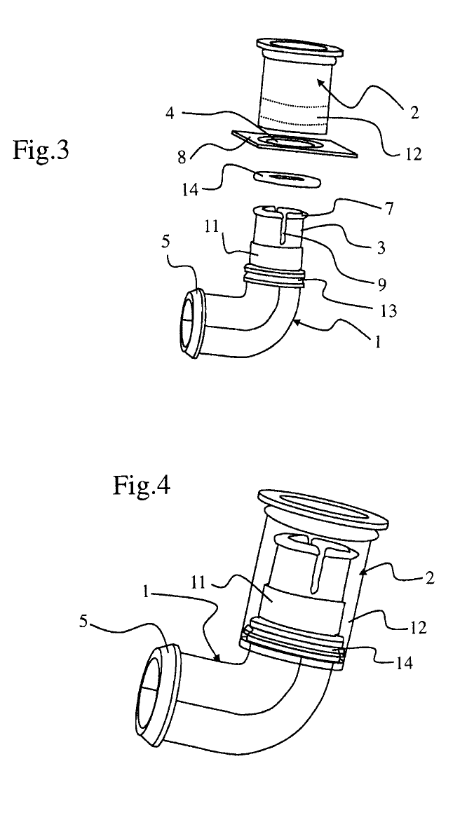

FIG. 3 depicts an exploded view of the arrangement according to the embodiment of the invention;

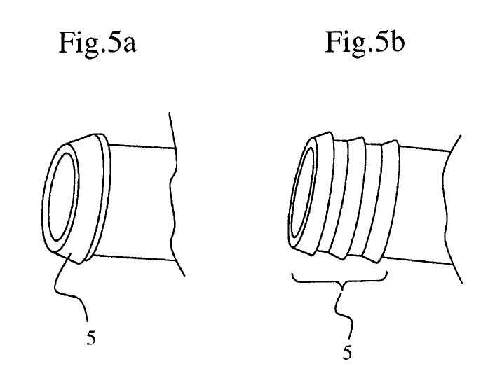

FIG. 4 depicts a view of the above arrangement after assembly;

FIGS. 5a and 5b depict details of a device of the arrangement according to the embodiment of the invention.

According to the invention, water is removed by the arrangement of two main elements, a plastic component 1 combined with a means of engagement 2.

The means of engagement 2 is designed for fitting in a substantially vertical position directly in an opening 4 made in the structure of the roof, near a corner 6 of the roof, in the immediate vicinity of the cross member 10 of the structure of the vehicle. In the case of a vehicle with a large sunroof, this opening is made in a corner reinforcing piece 8.

In one particularly advantageous embodiment, the means of engagement 2 may consist of a sunken nut, allowing it to be fitted blind into the opening 4. It is crimped to the sheet metalwork panel by pulling and as the roof passes through a cataphoresis oven, its hot melt seal or gasket flows and mechanically seals the means of engagement 2 to the body shell.

According to the embodiment illustrated in the figures, the means of engagement 2 consists of a cylindrical nut, that has a tapped thread 12. As an alternative, this nut could have some other form exhibiting grooves and shoulders, without departing from the context of the invention.

The arrangement according to the embodiment of the invention additionally comprises a plastic component 1 comprising a first end 3 intended for connection to the means of engagement 2 and a second end 5 designed for connecting to a water discharge pipe which has not been depicted. The plastic component forms a bend at a predefined angle so as to connect the substantially vertical part of the means of engagement 2 leading from the roof of the motor vehicle to the water discharge pipe.

The first end 3 of the plastic component, which may for example be made of polyamide, comprises means 7 of connection by clip fastening to the counterbore of the means of engagement 2, and a tapped thread 11 engaging with the tapped thread 12 of the means of engagement 2. Finally, it comprises a polarizing lug 9 which ensures it is correctly orientated when mounted on the means of engagement 2.

Its second end 5, illustrated in FIG. 5a, has an olive feature for connecting to a discharge pipe.

FIG. 5b depicts an alternative form of embodiment in which this end is of a ribbed appearance. The pipe could be attached to the end 5 of the plastic component in various ways, clipping, adhesive bonding, ultrasonic welding, etc.

The plastic component 1 can be produced in a single injection-molding operation by injecting plastic into a single-cavity or multi-cavity mold. Thereafter, a holmet seal 14 can be fitted into a location 13 provided on this component. As an alternative, a substance that swells can be injected into the mold to form the seal 14 in a two-shot injection molding manufacturing solution.

The solution described thus meets the desired objectives and offers the following advantages:

the arrangement is suited to any type of automotive vehicle roof and reduces the areas in which water can accumulate,

the arrangement is simplified and relies upon a plastic component that can be standardized and used across many vehicles;

the final fitting of the discharge pipe to the plastic component is very simple.

1-9. (canceled)

10. A device of an arrangement for removing water for a motor vehicle, taking form of a bent plastic component comprising:
a first end configured to connect with a means of engagement for a sheet metalwork panel of a motor vehicle; and
a second end configured to connect to a water discharge pipe.

11. The device of an arrangement for removing water for a motor vehicle as claimed in claim 10, wherein the first end configured to connect to a means of engagement comprises a means configured to be clipped into a counterbore of the means of engagement.

12. The device of an arrangement for removing water for a motor vehicle as claimed in claim 10, wherein the first end configured to connect to a means of engagement comprises a tapped thread.

13. The device of an arrangement for removing water for a motor vehicle as claimed in claim 10, wherein the first end configured to connect to a means of engagement comprises at least one polarizing lug to ensure correct orientation of the device.

14. The device of an arrangement for removing water for a motor vehicle as claimed in claim 10, wherein the plastic component includes a housing configured to accept a seal.

15. A method of manufacturing a device of an arrangement for removing water for a motor vehicle, comprising:
injecting a plastics material into a mold to form a bent plastic component comprising a first end configured to connect to a means of engagement for a sheet metalwork panel of a motor vehicle, and a second end configured to connect to a water discharge pipe.

16. An arrangement for removing water from a roof of a motor vehicle, comprising:
means of engagement to be fitted into an opening in the roof of the motor vehicle; and
a bent plastic component comprising a first end configured to connect with the means of engagement, and a second end configured to connect to a water discharge pipe.

17. The arrangement for removing water from the roof of a motor vehicle as claimed in claim 16, wherein the means of engagement forms a sunken nut allowing it to be fitted blind into the opening in the roof of the motor vehicle, and configured to be crimped to the sheet metalwork panel by pulling.

18. A motor vehicle comprising an arrangement for removing water from its roof as claimed in claim 16.
